(19) United States
(12) Patent Application Publication
(10) Pub. No.: US 2003/0225687 A1
(43) Pub. Date: Dec. 4, 2003

(54) Travel related risk management clearinghouse

(76) Inventor: David Lawrence, New York, NY (US)

Correspondence Address: Joseph P. Kincart, Esq., Clifford Chance US LLP, 200 Park Avenue, New York, NY, 10016, US

(21) Appl. No.: 10/456,000

(22) Filed: Jun. 6, 2003

Related U.S. Application Data
(63) Continuation-in-part of application No. 10/074,584, filed on Feb. 12, 2002.
Application No. 10/074,584 is a continuation-in-part of application No. 10/021,124, filed on Oct. 30, 2001.
Application No. 10/021,124 is a continuation-in-part of application No. 09/812,627, filed on Mar. 20, 2001.
(63) Continuation-in-part of application No. 10/313,202, filed on Dec. 6, 2002.
(60) Provisional application No. 60/387,161, filed on Jun. 7, 2002.

(51) Int. Cl. G06F 17/60

(52) U.S. Cl. 705/38

(57) ABSTRACT

Computerized methods and systems for facilitating analysis and quantification of risk associated with a Travel Arrangement. A travel related risk management clearinghouse system associates informational artifacts with data descriptive of a travel arrangement and maintains a database to relate to risk criteria. In some embodiments it can also calculate a measurement of risk. The measurement, which can be a risk quotient or other rating based upon a weighted algorithm applied to the risk criteria, can be indicative of risk associated with the risk subject. Actions commensurate with a risk quotient can be presented to a user to facilitate management of risk associated with a particular entity or travel arrangement or other travel arrangement. A stored history can be created to mitigate adverse effects relating to a problematic travel arrangement.

### CROSS-REFERENCE TO RELATED APPLICATIONS

This application claims the benefit of the filing date of U.S. provisional application No. 60/387,161 entitled “Risk Management Clearinghouse Traveler Check,” filed Jun. 7, 2002. This application is also a continuation-in-part of a U.S. patent application Ser. No. 10/074,584 entitled “Risk Management Clearinghouse” filed Feb. 12, 2002, which is a continuation-in-part of a U.S. patent application Ser. No. 10/021,124 entitled “Risk Management Clearinghouse” filed Oct. 30, 2001, which is a continuation-in-part of U.S. patent application Ser. No. 09/812,627 entitled “Automated Global Risk Management” filed Mar. 20, 2001. The present application is also a continuation-in-part of a U.S. patent application Ser. No. 10/313,202 entitled “Charitable Transaction Risk Management Clearinghouse” filed Dec. 6, 2002, all of which are relied upon and incorporated by reference.

### BACKGROUND

This invention relates generally to methods and systems for facilitating the identification, investigation, assessment and management of legal, regulatory, physical and reputational risks (“Risks”). In particular, the present invention relates to computerized systems and methods for a user to access information and artifacts compiled on a worldwide basis and relate such information to a travel arrangement, which includes at least one traveler.

As anti-terrorism and related concerns have become increasingly important public policy concerns, law enforcement officials have attempted to address these issues by imposing increasing formal and informal obligations upon travel providers. Government interests and law enforcement efforts authorize a broad regime of security oriented obligations, record-keeping and regulatory obligations on travel providers. The efforts may require Travel Providers to conduct security measures and to maintain and check certain records for possible use in anti-terrorist, anti-criminal and other security and law enforcement efforts and proceedings.

However, the travel industry is generally geared to providing travel services and is not well equipped to screen passengers or circumstances in order to ascertain anomalies or high risk activities. For example, a travel provider may be ill equipped to ascertain whether a traveler or a source of payment for travel related expenses is associated with a terrorist group or other high risk entity. The travel industry is geared towards providing efficient and economical travel, not towards screening travelers or the source of payment for travel related expenses.

Risks and indications of Risks can be multifaceted and far reaching. Generally, personnel in the travel industry do not have available a mechanism to provide real time assistance to assess a risk factor or otherwise qualitatively manage travel related risk. In the event of problems, it is often difficult to quantify to law enforcement bodies, shareholders, newspapers and other interested parties, the diligence exercised by the travel provider to properly identify and respond to risk factors. Absent a means to quantify good business practices and diligent efforts to contain risk, the travel provider may appear to be negligent in some respect.

What is needed is a method and system to draw upon information gathered globally and utilize the information to assist with risk management and due diligence related to travel arrangements. A new method and system should anticipate offering guidance to personnel who interact with travelers or shippers and help the personnel identify high risk situations. In addition, it should be situated to convey risk information to a compliance department and be able to demonstrate to law enforcement and other interested parties that a Travel Provider has met standards relating to risk containment.

### SUMMARY

To alleviate problems inherent in the prior art, the present invention introduces systems and methods to facilitate ascertaining and managing Risks associated with a Travel Arrangement.

According to some embodiments a computer implemented method is presented for managing risk related to a travel arrangement. The method can include the steps of receiving into a computer system data descriptive of informational artifacts with content generally related to at least one of: reputational, regulatory and physical risk, physical risk or security risk and defining within the computer system one or more travel arrangement risk criteria. The computer system can also receive data descriptive of a travel arrangement that includes identification data for at least one traveler and associate the data descriptive of the travel arrangement with one or more risk criteria and with one or more informational artifacts related to at least one of: reputational, regulatory and physical risk. A report can also be generated with contents comprising the data descriptive of a travel arrangement that is associated with one or more risk criteria and associated with one or more informational artifacts related to at least one of: reputational, regulatory and physical risk and also comprising a description of the one or more informational artifacts associated with the data descriptive of a travel arrangement and a description of the risk criteria.

According to other embodiments. It is also arranged for the data descriptive of the at least one travel arrangement to include a payment vehicle for at least one travel reservation.

Still other embodiments can include generating in the computer system a risk quotient indicative of a quantitative amount of at least one of: reputational risk; physical risk, legal risk and regulatory risk; and the risk quotient is based upon at least one of: the risk criteria associated with the data descriptive of a travel arrangement; a weighted value of the data associated with such risk criteria; and the content of an informational artifact associated with the data descriptive of a travel arrangement.

Embodiments can also include generating a suggested action based upon at least one of: the risk criteria associated with the data descriptive of a travel arrangement; a weighted value of the data associated with such risk criteria; and the content of an informational artifact associated with the data descriptive of a travel arrangement. The suggested action may or may not require gathering or otherwise receiving additional details descriptive of at least one of: a traveler; a financial account associated with a payment for the travel arrangement; a pattern of destinations comprising the travel arrangement; and articles involved in the travel arrangement. Other suggested actions can include completing the travel arrangement and notifying at least one of: a security personnel, law enforcement agency; a government official and a travel provider.

According to still other embodiments, the report can be presented to at least one of: security personnel and law enforcement personnel that will travel on the travel arrangement.

In another aspect, the method can include the steps of associating data relating to one or more seating assignments comprising a travel arrangement with the report contents.

Other embodiments are directed to methods that can performed by a computer system and include the steps of: receiving into the computer system data descriptive of informational artifacts with content generally related to travel arrangements and at least one of: reputational, regulatory and physical risk. One or more travel arrangements can be identified and data descriptive of any travel reservations made for each travel arrangement can be received into the computer system. In some embodiments, the travel reservation can include identification data for one or more travelers.

One or more travel related risk criteria can be defined within the computer system and the computer system can associate at least some of the data descriptive of at least one travel reservation with one or more of the risk criteria related to at least one of: reputational, regulatory and physical risk. At least some of the data descriptive of at least one travel reservation can be associated with data descriptive of one or more informational artifacts related to at least one of: reputational, regulatory and physical risk. A report can be generated with contents that include the data descriptive of the travel arrangement that is associated with one or more of the risk criteria and associated with one or more of the informational artifacts and also include a description of the one or more informational artifacts associated with the data descriptive of a travel arrangement.

In yet other embodiments the step of selecting a preferred travel arrangement can be based upon the contents of the report. It is also possible for the travel arrangement to be identified based upon an origination point and a destination point of the travel arrangement or for the travel arrangement to be identified based upon the details of the travel arrangement which can include one or more of: an origination point and a destination point of the travel arrangement; a scheduled time for the travel arrangement; a number of connections involved in the travel arrangement; and a preferred provider for the travel arrangement.

Still other embodiments can include receiving into a computer system data descriptive of informational artifacts with content generally related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement. One or more of the informational artifacts can be associated with content generally related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement.

Some embodiments include the report being generated with additional contents descriptive of the artifacts related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement. In addition, in some embodiments, a preferred travel arrangement can be selected based upon the contents of the report. In still other aspects, the data descriptive of travel reservations can include a payment vehicle and the method can additionally include the step of performing a risk management clearinghouse check on a person associated with the payment vehicle. The methods presented can also include generating in the computer system a risk quotient for one or more travel reservations, wherein the risk quotient is indicative of a quantitative amount of at least one of: reputational risk; physical risk, legal risk and regulatory risk; and the risk quotient is based upon at least one of: the travel related risk criteria; a weighted value of the data associated with the travel related risk criteria; and the content of an informational artifact associated with the data descriptive of a travel arrangement.

According to still other embodiments, two or more risk quotients can be aggregated, and each risk quotient can be indicative of an amount of one of: reputational risk; physical risk, legal risk and regulatory risk associated with a travel reservation, and the aggregation of the risk quotients is indicative of a total quantitative amount of such risk associated with the travel arrangement. The report can also include an association of one or more of: the data descriptive of the travel arrangement; the risk criteria; and the informational artifacts with a seating assignment associated with the travel arrangement.

Other embodiments are directed to a computerized system for implementing various method steps described herein and a computer executable program code residing on a computer-readable medium, the program code comprising instructions for causing a computer to also implement the method steps described herein.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1A is a block diagram overview of some implementations of the present invention.

FIG. 1B is a block diagram overview of a communication system according to some embodiments of the present invention.

FIG. 2A is a flow chart of a method according to some embodiments of the present invention.

FIG. 2B is a flow chart of additional methods according to some embodiments of the present invention.

FIG. 2C is a flow chart of additional methods according to some embodiments of the present invention.

FIG. 2D is a flow chart of additional methods according to some embodiments of the present invention.

FIG. 3 is a system overview according to some embodiments of the present invention.

FIG. 4 is diagram of a controller that can be utilized to implement some embodiments of the present invention.

FIG. 5 is a tabular representation of a portion of a travel information management database according to some embodiments of the present invention.

FIG. 6 is a tabular representation of a portion of a risk management database according to some embodiments of the present invention.

FIG. 7 illustrates a graphical user interface that can be utilized with some embodiments of the present invention.

### DETAILED DESCRIPTION

The present invention includes computerized methods and systems for managing risk related to travel arrangements. A computerized system gathers and stores data descriptive of informational artifacts in a database or other data storing structure and relates the information to risk criteria and details of a travel arrangement. A user can supply details of a travel arrangement to the database to assess risk associated with the travel arrangement. The computerized system relates the details supplied with specified risk criteria and informational artifacts in order to generate a report that correlates informational artifacts with risk criteria and the details of the travel arrangement. In some embodiments, the report can be utilized by a Travel Provider to assess Risks associated with a particular travel arrangement, or to assess aggregate Risks faced by the Travel Provider. Other embodiments can include an assessment from a traveler's perspective seeking to assess potential risk with a particular travel arrangement or with a travel provider. In particular, a Travel Provider may be able to use the Risk assessment to promote Travel Arrangements associated with the Travel Provider, by claiming adherence to specified Risk management practices.

Risk associated with a Traveler involved in international travel can be greatly increased due to the difficulty in gathering and accessing pertinent data on a basis timely to managing risk associated with the travel. As part of due diligence associated with arranging or providing travel, there is a growing importance for a Travel Provider to “Know Their Traveler” including whether a Traveler is contained on a list of restricted persons published or maintained by a law enforcement agency, the Office of Foreign Access Control (OFAC), the Treasury Office or other government or industry organization or entity involved with containing Risks.

In some embodiments, a rating, such as a risk quotient can be generated to readily indicate a level of risk associated with a particular travel arrangement or traveler. The risk quotient can be based upon a weighted algorithm applied to the Risk criteria and informational artifacts. The risk quotient can be made available on a periodic basis, on demand in real time, in response to an event such as booking a travel arrangement, or according to some other request. Some embodiments can also include generation of suggested actions commensurate with ascertained Risks.

### Definitions

To aid in the description of the present invention, the following definitions can apply to terms utilized throughout this document:

Travel Arrangement: a Travel Arrangement refers to a provision for assisting a Traveler execute a travel agenda. As such, a Travel Arrangement can include, for example, a designated: flight, train service, water travel service, bus service, car service, hotel accommodation, entertainment event and dining establishment.

Travel Provider: a Travel Provider refers to any person, entity, company, corporation or statutory “person” in the business of providing Travel Arrangements. As such a Travel Provider can include: an airline, a rail or train operator, a busing operator; a mass transit operator; a travel agency; a travel agent; a cruise or shipping provider and a shipping agent.

Traveler: refers to a person who will make use of a Travel Arrangement.

Risks: Risks associated with a travel arrangement can include factors associated with security risk, financial risk, legal risk, regulatory risk and reputational risk. A Security Risk refers to breach of a safety measure that may result in unauthorized access to a facility; unauthorized access to data; physical harm, including threat of immediate risk of harm to a person or goods. Financial Risk refers to factors indicative of monetary costs that the Travel Provider or a Traveler may be exposed to as a result of a particular travel arrangement. Monetary costs can be related to fines, forfeitures, costs to defend an adverse position, lost revenue, or other related potential sources of expense. Regulatory Risk refers to factors that may cause the Travel Provider or Traveler to be in violation of rules put forth by a government entity or regulatory agency. Reputational risk relates to harm that a Travel Provider or Traveler may suffer regarding its professional standing in an industry or the public eye. A Travel Provider and Traveler can suffer from being associated with a situation that may be interpreted as contrary to an image of diligence, honesty and forthrightness.

Risk Management Clearinghouse (RMC): refers to computerized systems and methods for managing Risks and associating information useful for quantifying Risk with a Risk subject, as more fully described in the related patent applications: Ser. No. 10/074,584 entitled “Risk Management Clearinghouse” filed Feb. 12, 2002, and U.S. patent application Ser. No. 10/021,124 entitled “Risk Management Clearinghouse” filed Oct. 30, 2001.

### Elements

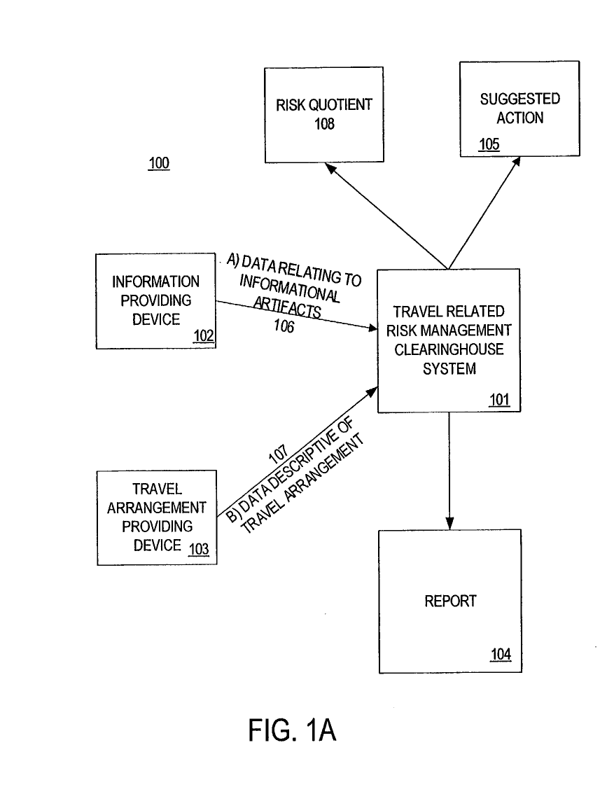

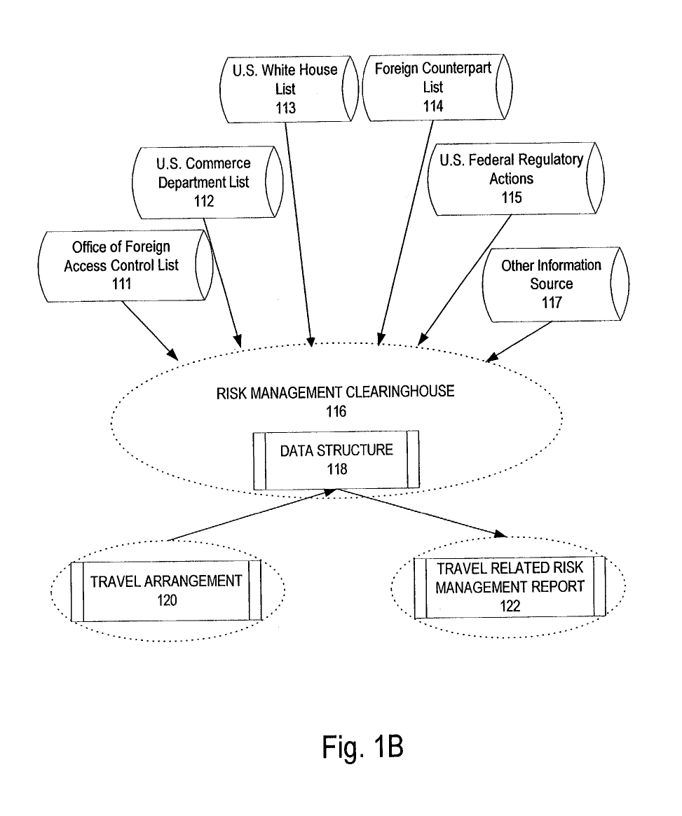

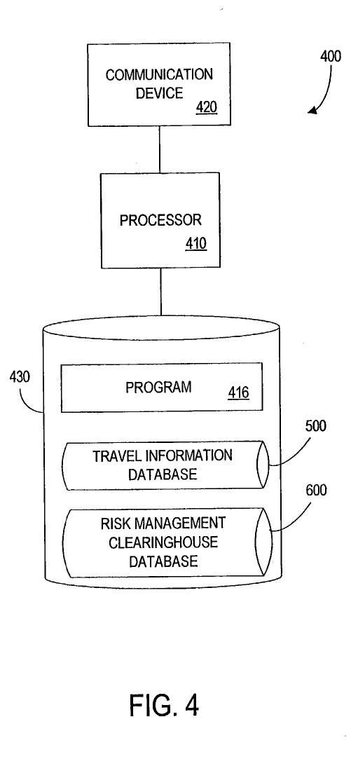

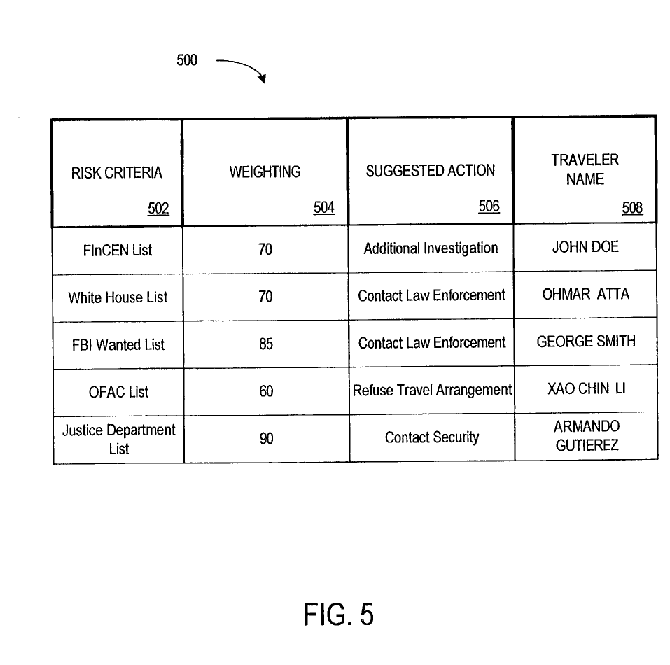

Referring now to FIG. 1A, a block diagram including elements of some embodiments of the present invention is illustrated. A Travel Related Risk Management Clearinghouse (TRRMC) system 101, receives data relating to informational artifacts 106 from an information providing device 102. The TRRMC System 101 can include a computerized system programmed or otherwise functioning to perform the various inventive functions described herein. A detailed description of some embodiments of a TRRMC System 101 are disclosed herein with particular implementations discussed in relation to FIGS. 4 and 5.

An information providing device 102 can be associated with a source of data that describes artifacts, or provides artifacts, or copies of artifacts that are generally related to Risk, and in particular with reputational, regulatory, security or physical risk. Discussion of a source of data and examples thereof are further discussed in below relation with FIG. 4.

Data relating to informational artifacts 106 can be varied according to a source or type of data and generally include any data which can be presented as humanly discernable information. It can also include actual copies of artifacts or portions thereof, such as, for example, a copy of a government report, a news article, a document, a transcript, a cite, a court record, or other article. Embodiments can include data relating to informational artifacts 106 that is periodically updated, constantly updated in real time, or updated in response to a request.

The TRRMC 101 can also receive data descriptive of a travel arrangement 107. The data descriptive of the travel arrangement 107 can vary depending upon a type of travel arrangement, but generally can include identification of a traveler, origination and destination points, payment vehicle, mode of travel, specific schedule (such as flight number, or scheduled train or bus service, ship out date, car service etc.), facility involved, lodging and restaurant reservation.

The data descriptive of a travel arrangement 107 can be received from a travel arrangement providing device 103 which will typically be utilized by a Travel Provider.

The TRRMC System 101 can determine which data relating to informational artifacts 106 is associated with the one or more travel related risk criteria and the information descriptive of a travel arrangement 107 and generate a report and/or a suggested action based upon the data received. The data relating to informational artifacts 106 can be associated with a risk criteria or other subject with programmed data association techniques, such as, for example, keyword search, fuzzy logic, artificial intelligence programs, full text, numerical value, financial value, coded entry or other well known or proprietary forms of data manipulation.

Output from the TRRMC 101 can include reports 104 containing data descriptive of a travel arrangement 107, risk criteria and informational artifacts. Reports can generated that are conducive to the needs of a particular recipient or the report. For example, a report can be generated for an airline security personnel that contains information particularly useful to the airline and a report for a traveler can include information more useful to the traveler. Embodiments can therefore include reports 104 generated for a graphical user interface, hardcopy, facsimile, e-mail, messaging or other communication with any humanly or machine discernable data and/or artifacts. In some embodiments, output can include transmitting the risk criteria related data 104 to a designated recipient. any humanly or machine discernable data and/or artifacts.

In some embodiments, the TRRMC System 101 can also output a risk quotient 108, or other quantitative measurement that indicates an amount of risk that is associated with a particular Travel Arrangement. If desired, an aggregate of risk quotients can be calculated in order to ascertain a total amount of risk associated with an entity, such as a Travel Provider.

In some embodiments a suggested action 105 can be generated by the TRRMC System 101 based upon the risk quotient 108 and the data descriptive of the artifacts 106, and the travel arrangement 107. The suggested action 105 can help a user determine an appropriate response to a given set of circumstances. In addition, a suggested action can mitigate risk by allowing a user to demonstrate adherence to a quantifiable set of procedures aimed to meet practice norms. Some embodiments can also allow a TRRMC system 101 to automatically respond to certain risk quotient 108 values. For example, if a transaction reaches or exceeds a risk quotient threshold, the TRRMC system 101 can respond with a predetermined action such as, generating an alert, blocking acceptance of a Travel Arrangement or Travel Reservation, creating a report, notifying a compliance department, or other appropriate response.

Referring now to FIG. 1B, a block diagram illustrates a flow of data in some implementations of the present invention. For example, informational data 106 can be received from a variety of information sources 111-117 such as, for example: a list generated by the Office of Foreign Assets Control (OFAC) 401, including their sanction and embargo list; a list generated by the U.S. Commerce Department 402; a list of international “kingpins” generated by the U.S. White House 403; a list generated by a foreign counterpart to a U.S. entity 404; U.S. regulatory actions 405; or other information source 407 such as a foreign government, US adverse business-related media reports, US state regulatory enforcement actions, international regulatory enforcement actions, international adverse business-related media reports, a list of terrorist organizations, a list of politically connected individuals and military leaders, a list of U.S. and international organized crime members and affiliates, or a list of recognized high risk countries. Court records or other references relating to fraud, bankruptcy, professional reprimands or a rescission of a right to practice, suspension from professional ranks, disbarment, prison records or other sources of suspect behavior can also be included as a source of informational data and artifacts, as can public documents and publications such as newspapers, periodicals, news feeds, internet postings, government filings or other source of information. Many embodiments can also include information data sources which are various foreign equivalents to those listed above or any other international source.

Informational data can be received and stored in a data structure 118 for subsequent access as part of a risk management query. Data descriptive of a Travel Arrangement 107 can also be received and stored in the data structure 118.

In order to facilitate receipt of information related to a Travel Arrangement, a series of structured questions can be presented to a Travel Provider. A log or other stored history can be created such that utilization of the system can mitigate adverse effects relating to a problematic Travel Arrangement. Mitigation can be accomplished by demonstrating to law enforcement bodies, government agencies, donors, charity recipients, regulatory bodies, shareholders, news media and other interested parties that corporate governance is being addressed through tangible risk management processes which include continual gathering of risk related information and application of the risk related information to Travel Arrangements to assess a level of risk.

In some embodiments, the TRRMC system 101 can also receive an open query, which may or may not necessarily be associated with a particular Travel Arrangement. For example, a user may wish to conduct research relating to a particular Travel Reservation or Traveler. An open query allows disparate information to be input and searched.

Some embodiments can include one or more risk criteria that are automatically generated as a result of monitoring transactions being conducted by a computerized system utilized for processing Travel Arrangements. For example, an information system involved in making Travel Resevations can be electronically scanned for key words. Traveler names, entity names, high risk destinations or origination locations, or other pertinent data. A query can be formulated based upon one or more risk criteria ascertained as a result of the electronic scan. The query can be and run against the data structure 108 maintained in the TRRMC system 101.

Still other embodiments can include a voice query via a telephone or other voice line, such as voice over internet, fax, electronic messaging, or other means of communication, a query input into a GUI, or other means.

If appropriate, some embodiments can include an alert list containing one or more particular risk subjects, such as, for example a name of a particular traveler or a particular account used for payment. The TRRMC system 101 can continually monitor data in its database via an alert query with key word, fuzzy logic or other search algorithms and transmit related informational data, associated risk quotients, suggested actions or other output to the interested party. In this manner, ongoing diligence can be conducted. In the event that new information is uncovered by the alert query, the subscriber can be immediately notified, or notified according to a predetermined schedule. Appropriate action can be taken according to the information uncovered.

A log or other stored history can be created by a TRRMC system 101 to mitigate adverse effects relating to a problematic traveler or travel arrangement. Mitigation can be accomplished by demonstrating to regulatory bodies, shareholders, news media and other interested parties that corporate governance is being addressed through tangible risk management processes.

Some embodiments can include monitoring of one or more Travel Arrangements to ascertain if a Travel Arrangement reaches or exceeds a Risk threshold. In response to reaching or exceeding a Risk threshold, the TRRMC 101 can perform a predetermined action or series of actions, such as alert a designated party, including, for example: an associated Travel Provider; a compliance department; a law enforcement authority; security personnel; a person in command of a transportation vehicle, such as a pilot, captain, or train engineer or conductor; or other designated party. In addition, a responsive action can include blocking acceptance of additional Travel Reservations associated with the Travel Arrangement or Travel Provider exceeding the threshold.

In the case of an automated Travel Arrangement, such as, for example, execution of an online Travel Arrangement, a direct feed of information can be implemented from a front end system involved in the Travel Arrangement to the TRRMC system 101 or via questions that are presented to a Travel Arrangement initiator by a programmable robot via a GUI. Questions can relate to a particular type of travel, a particular type of traveler, origination or destination points, as well intermediary points, or other criteria. In addition, travel records can relate Travelers who travel on one or more common travel vehicles, such as passengers on an airplane, and flag any patterns that can indicate high risk.

Other embodiments can include an information system that electronically scans Travel Arrangement data for key words, entity names, geographic locales, or other pertinent data. Programmable software can be utilized to formulate a query according to suspect names or other pertinent data and run the query against a database maintained by TRRMC 101.

In various embodiments, data scrubbing routines can be utilized to facilitate ascertaining Risks. The routines can include programs capable of correcting a specific type of mistake, such as, for example, an incomprehensible address, or clean up a full spectrum of commonly found database flaws, such as field alignment that can pick up misplaced data and move it to a correct field or removing inconsistencies and inaccuracies from like data. Other scrubbing routines can be directed directly towards specific legal issues, such as money laundering or terrorist tracking activities.

Embodiments of scrubbing routines can facilitate detection of various different spelling of one name. In particular, spelling of names can be important when names have been translated from a foreign language into English. For example, some languages and alphabets, such as Arabic, have no vowels. Translations from Arabic to English can be very important for financial institutions seeking to be in compliance with lists supplied by the U.S. government that relate to terrorist activity and/or money laundering. A data scrubbing routine can facilitate risk variable searching for multiple spellings of an equivalent name or other important information. Such a routine can enhance the value of stored data 118 and also help correct database flaws. Scrubbing routines can improve and expand data quality more efficiently than manual mending and also allow a user to quantify best practices for regulatory purposes. Data aggregated into an TRRMC 101 can also be augmented to further facilitate rigorous risk management. Augmenting data can include data mining techniques that utilize software to analyze and sift through the stored data 118 and implement techniques such as mathematical modeling, statistical analysis, pattern recognition, rule based trends or other data analysis tools. Embodiments that implement augmenting techniques can provide risk related searching with an added discovery dimension and return results that a human operator may find labor and cognitively intense. Discovery dimensions can include the extraction of implicit, previously unknown and potentially useful information from the data 118 stored in the TRRMC. This type of extraction can include, for example, correlation, patterns or trends in the data 118. Some embodiments can also include techniques such as fuzzy logic and/or inductive reasoning tools.

Augmenting routines can therefore include enhancing available data with routines designed to reveal hidden data. Revealing hidden data or adding data fields derived from existing data can be very useful to risk management. For example, supplied data may not include an address for a person wishing to perform a particular fund transfer, or the address may be invalid; however a known telephone number may be available. Augmenting data can include associating the telephone number with a known geographic area or, jurisdiction. The geographic area may be a political boundary, or coordinates, such as longitude and latitude coordinates, or global positioning coordinates. The geographic area identified can then be qualified as a high risk or low risk variable.

An additional example of augmented data derived from a telephone number can include associating a given telephone number with a high risk entity, such as a person listed on an OFAC list.

### Methods

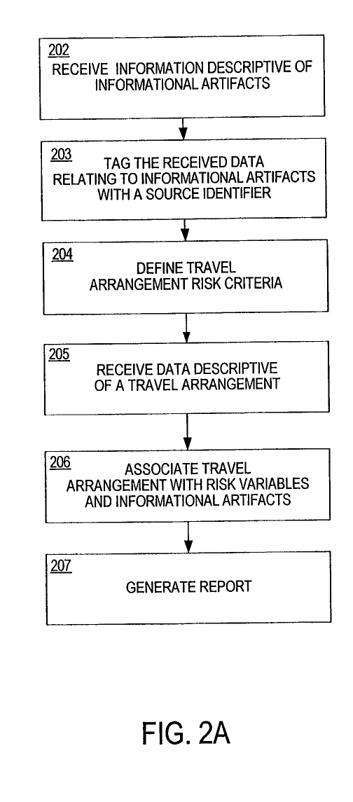

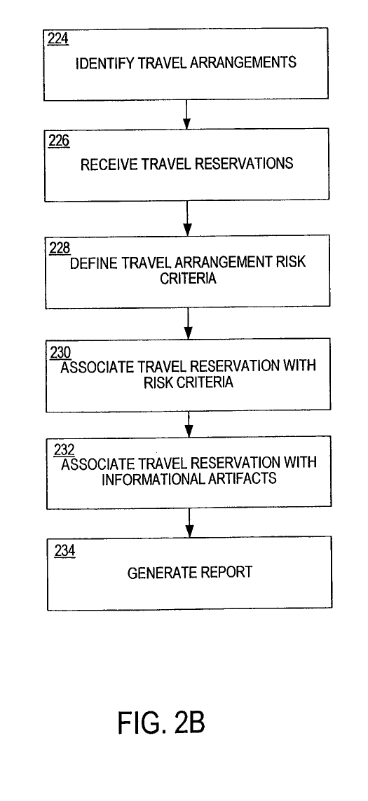

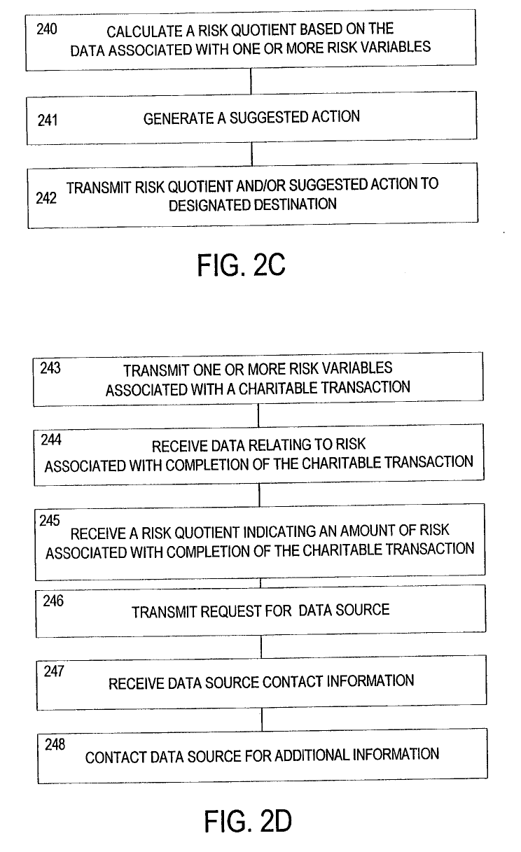

Referring now to FIG. 2A, steps are illustrated which can be utilized to manage risk associated with a Travel Arrangement according to the present invention. At 202, a TRRMC 101 can receive informational data descriptive of artifacts 106 from an information providing device 102. An information providing device 102 can be associated for example with those sources discussed in conjunction with FIG. 1B and also, for example from any other appropriate source, such as, an investigation firm, external database, messaging system, news feed, government agency, or other data provider. In some embodiments, information can be received on an ongoing basis such that if new events occur in the world which affect the risk exposure of a transactor, an estimated risk value can be adjusted accordingly.

At 203, in some embodiments, the TRRMC 101 can tag the received data relating to informational artifacts 106 with a source identifier. The source identifier can include additional datum that is indicative of a person, place or entity that provided information to the TRRMC 101. In some embodiments, a profile can be maintained containing data descriptive of each source, including contact information, such as contact name, address, telephone number, e-mail address, instant messenger address, or any other indication of how to communicate with a particular source.

At 204, Travel Arrangement risk criteria can be defined. For example, risk criteria associated with a Travel Arrangement can include: inclusion of a traveler's name on a list from a government agency, records of previous adverse experience with a traveler, travel to or from defined political areas, passengers with defined background, passengers with defined travel habits or luggage, payment from a financial account associated with high risk, groups of high risk individuals, any special requests or requirements associated with one or more travelers and noted statements or behaviour associated with a traveler.

At 205, the TRRMC 101 can receive data descriptive of a Travel Arrangement. The data descriptive of the travel arrangement can include a description of a travel mechanism, such as an air flight, a scheduled train, a scheduled bus, a car service, which in turn can include more details such as, for example. a type of plane, a number of passengers, how cargo is stored, safety records for a particular model of airplane, safety records for the particular plane involved, how old the carriers fleet is, how old a particular plane involved is, equipment with which the plane is outfitted, or other details. Similar detail can be included for various other types of travel, such as water travel, bus travel, auto travel, etc.

The data descriptive of the travel arrangement 107 can also include data descriptive of one or more travelers involved. The data descriptive of the travelers should include identification data, such as, for example: the traveler's name, date of birth, place of birth, citizenship, passport number, social security number, government identification number, military identification number, residential address, business address, telephone number, account number, biometric identification, such as an iris scan or fingerprint, or other means of identification.

Still other data descriptive of the travel arrangement 107 can also include data descriptive of a payment vehicle, such as method of payment and identification of an account used to process payment.

At 206, the TRRMC 101 can associate data descriptive of the travel arrangement 107 with one or more risk criteria. Association of the data with the risk criteria can be accomplished utilizing various well know techniques for manipulating or matching data. Associations can be made for example by matching names on a list generated by a government agency with a traveler's name, matching a pattern of travel in the Travel Arrangement with a pattern indicative of a high risk behavior, determining that an account utilized for payment of a Travel Arrangement is also associated with a known terrorist group, detecting an itinerary of travel locations that includes high risk areas for terrorism, illegal drug trade, illicit trade or other high risk activity.

At 207, a report can be generated that includes data descriptive of a Travel Arrangement that is associated with one or more risk criteria and is also associated with one or more informational artifacts. In some embodiments, reports can specifically include data that is associated with artifacts that is in turn associated with at least one of reputational, regulator, and/or physical risk, or other specific type of risk. Other embodiments can include various aspects of the informational data collected, such as, for example: a report quantifying due diligence efforts made in connection with a Travel Arrangement, which risk criteria were included in a risk management query, risk criteria data associated with the data as a result of the query, a risk quotient 108 generated, a suggested action 105 and data descriptive of a source of relevant data.

In some embodiments, the due diligence report can be transmitted to a designated destination, such as, for example, a compliance department, law enforcement personnel, security personnel, a legal department, a public relations person, or other destination.

Referring now to FIG. 2B, additional steps that can be implemented while practicing the present invention are illustrated. At 224, the TRRMC 101 can identify Travel Arrangements that may be conducive to the needs of a Traveler. The Travel Arrangements can be identified for example, based upon a desired date and/or time of Travel, a destination, an origination, a preferred Travel Provider, a preferred lodging, or other criteria. In addition, in some embodiments, a Travel Arrangement can identified based upon, a type of plane, a number of passengers, how cargo is stored, safety records for a particular model of airplane, safety records for the particular plane involved, how old the carriers fleet is, how old a particular plane involved is, equipment with which the plane is outfitted, or other details.

At 226, data descriptive of one or more Travel Reservations can be received into a computer system implementing the present invention. The Travel Reservation should include identification data for at least one Traveler, and can also include, for example, a description of a travel mechanism, such as an air flight, a scheduled train, a scheduled bus, a car service, lodging or other reservation data.

At 228, Travel Arrangement risk criteria can be defined, as discussed above and at 230 the data descriptive of at least some, or each, of the Travel Reservations can be associated with one or more of the risk criteria. In some embodiments, the risk criteria can relate to one or more specific types of Risk, such as, for example, security, reputational, regulatory or physical risk.

At 232, the data descriptive of at least some, or each, of the Travel Reservations can be associated with data descriptive of one or more of the informational artifacts received by the TRRMC 101. In some embodiments, the informational artifacts can relate to specific types of risk, such as, for example, security, reputational, regulatory or physical risk.

At 234, a report can be generated that includes data descriptive of the travel arrangement that is associated with one or more of the risk criteria and which is associated with one or more of the informational artifacts. The report can also include a description of the one or more informational artifacts associated with the data descriptive of a travel arrangement.

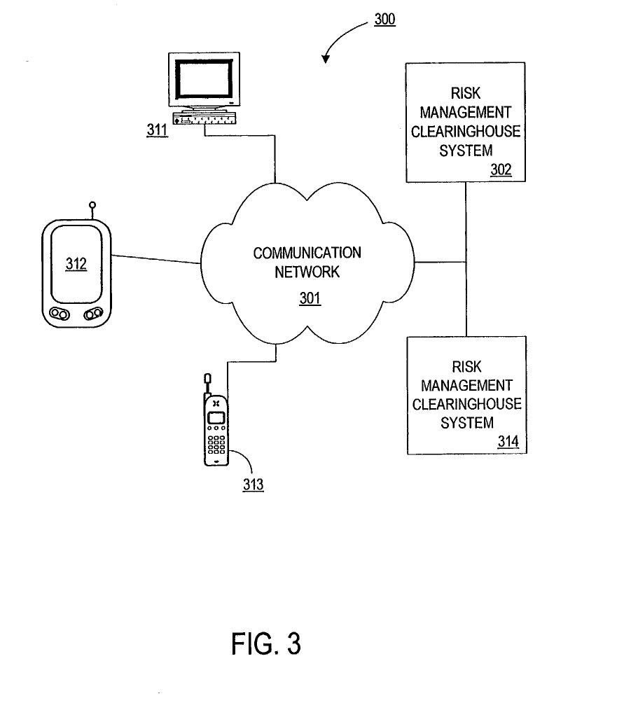

Referring now to FIG. 3A, further steps that can be implemented while implementing certain aspects of the present invention are illustrated. At 240, a risk quotient 108 can be calculated that is based upon the risk criteria associated data and the data relating to informational artifacts 106. In some embodiments, a risk quotient 108 can be calculated by weighting the information received according to its importance in determining high risk activities, such as the likelihood of illegal, unethical or unsafe activity. Calculating a risk quotient can be accomplished by assigning a numerical value to risk criteria associated data, wherein the numerical value is representative of the risk associated with the particular data.

For example, it may be determined in one case that a Traveler is a corporate officer from a corporation domiciled in a G-7 country with a payment vehicle that is a corporate authorized credit card poses minimal risk. Therefore this information from the first case is assigned a low numerical value, or even a negative numerical value. In a second case, a Traveler may include an individual who appears on a list generated by the FATF and is attempting to travel to or from an area known to harbor terrorists and may be viewed as a high risk and assigned a high numerical value. In addition, a weight can be assigned to a TTRMC risk category to which the information is assigned. Therefore, a designated Traveler may receive a higher weight than another, or vice versa. A Risk Quotient can be calculated by multiplying a weighted numerical value of the specific information times the category weighting.

For example, the Traveler information may receive a numerical value of 18 because it is a relatively high risk criteria. In addition, Travel Arrangement information may be included in a Traveler profile category, wherein the donor profile is assigned a category weighting of 3. Therefore, the net score for this ownership structure is −18 times 3 or −54. Similarly the organization without an established track record may also receive a number indicating high risk, such as −15. The TTRMC risk quotient for the organization would be 15 times 3, or −45. All scores within the Company Profile can be summed to calculate a TTRMC risk quotient. A calculation can therefore include a TTRMC risk quotient equivalent to −54+−45 which equals −99, indicating a high risk. In some embodiments, weighted risk scores will be summed or otherwise aggregated to calculate an overall Risk quotient 108 score.

At 241, a suggested action 105 can be generated that is based upon, or otherwise responsive to, the risk criteria associated data, the risk quotient 108, or other factor. For example, in response to a high risk score a suggested action may be to not proceed with a related Travel Arrangement, or to notify an appropriate security personnel or government authority. In response to a low risk score, a suggested action 105 may indicate that a relevant Travel Arrangement should be completed. An intermediate risk quotient 108 may generate a suggested action indicating that additional information should be gathered, that Travel Arrangement associated with this Traveler or account should be monitored, or other interim measure.

At 242, the risk quotient 108 and/or the suggested action 114 can be transmitted to a designated destination. For example, the transmission can include an e-mail to a designated e-mail address, or transmitting a signal over a communications network to a receiving device that is operative to display an indication of the risk quotient 108 and/or the suggested action 114, such as, for example via GUI.

Referring now to FIG. 2D, a flow chart illustrates steps that a user can implement to manage risk associated with a Travel Arrangement. At 243, the user can transmit to the TRRMC 101 one or more risk criteria associated with the transaction. The transmission can be accomplished by opening a dialogue with a TRRMC 101. Typically, the dialogue would be opened by presenting a GUI to an access device or other computerized system. The GUI can be capable of accepting data input via a user input device. For example, a GUI can include a series of questions relating to a Travel Arrangement and user interactive portions for accepting input responsive to the questions. Alternatively, information can be received directly into fields of a database, such as from a commercial data source.

In some embodiments, automated monitoring software can run in the background of a normal transaction program and screen data traversing an application. The screened data can be processed to determine key words wherein the key words can in turn be transmitted to the TRRMC 101 as risk criteria. The TRRMC 101 can process the key words to associate Travelers, payment vehicles, destinations, travel patterns, or other data with risk criteria. Monitoring software can also be installed to screen data traversing a network or communications link, such as those utilized to implement travel reservation software programs. As such, for example, a travel agency, or Travel Provider, can conduct its day to day business of arranging for travel needs for Travelers, while an implementation of the present invention screens data resulting from its day to day operations. The screened data can be forwarded to as data descriptive of a Travel Arrangement 107 to the TRRMC 101.

At 244, a user can receive risk criteria associated data relating to Risk that may be associated with a Travel Arrangement. The data received can include, for example: text messages, copies or descriptions of artifacts, including for example a copy of related news articles, documents or any other risk criteria related data. At 245, the user can also receive a risk quotient indicating an amount of risk associated with completing a Travel Arrangement.

At 246, if a user wishes to follow up by receiving more information or additional details regarding data received, the user can request a link from the TRRMC 101 to an information source for particular information. For example, if the TRRMC 101 has information in an associated data structure indicating that a particular Traveler may have particular attributes that indicate high risk, the user may wish to obtain additional information descriptive of that Traveler. The TRRMC 101 may have tagged the information when it was received with an identifier of the data source, such as, for example an investigation firm. The user can request contact information for the investigation firm, that is the source of the relevant information in order to conduct individual follow up with the source, or to ascertain the credibility or veracity of the information, or for other reasons.

At 247, the user can receive the data source contact information, and at 248 the user can contact the data source for additional information.

### Systems

Referring now to FIG. 3, a network diagram illustrating some embodiments of the present invention is shown 300. An automated TTRMC system 314 can include a computerized server accessible via a distributed network 301 such as the Internet, or a private network. An automated travel transaction processing system 302 can also include a computerized server accessible via the distributed network 301. A user can use a computerized system or network access device 311-313 to receive, input, transmit or view information processed in the TTRMC system 314, transaction processing system 302, a peer device, or other network access device 311-313. A protocol, such as, for example, the transmission control protocol internet protocol (TCP/IP) can be utilized to provide consistency and reliability.

A system access device 311-313 can communicate with the TTRMC system 314 or transaction processing system 302 to access data and programs stored at the respective servers. A system access device 311-313 may interact with the TTRMC system 314 or transaction processing system 302 as if the servers were a single entity in the network 300. However, the TTRMC system 314 and transaction processing system 302 may include multiple processing and database sub-systems, such as cooperative or redundant processing and/or database servers that can be geographically dispersed throughout the network 300.

A server utilized in a transaction processing system 302 and TTRMC server 314 can include a processor, memory and a user input device, such as a keyboard and/or mouse, and a user output device, such as a display screen and/or printer, as further detailed in FIG. 4. Any server can also include one or more databases (500, 600 in FIG. 4), storing data relating to a Travel Arrangement, Traveler, informational artifact, associated risks, or other pertinent information. Information relating to and included in travel related risk management can be aggregated into a searchable data storage structure. Gathering data into an aggregate data structure 700, 800, such as a data warehouse, allows a server 302, 314 to have the data readily available for processing a risk management search associated with a Travel Arrangement. Aggregated data 108, 304 can also be scrubbed or otherwise enhanced to aid in searching.

Typically, an access device 311-313 will access a TTRMC server 314 using client software executed at the system access device 311-313. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from a server to the system access device 311-313 and executed at the system access device 311-313 as part of a TTRMC server 314. Other implementations include proprietary software installed from a computer readable medium, such as a CD ROM. The invention may therefore be implemented in digital electronic circuitry, computer hardware, firmware, software, or in combinations of the above. Apparatus of the invention may therefore be implemented in a computer program product tangibly embodied in a machine-readable storage device for execution by a programmable processor and method steps of the invention may be performed by a programmable processor executing a program of instructions to perform functions of the invention by operating on input data and generating output.

In some embodiments, data contained in a database can be scrubbed or otherwise enhanced. Data scrubbing can be utilized to store information in a manner that gives efficient access to pertinent data and facilitate expedient access to data.

FIG. 4 illustrates a controller 400 that can be descriptive of a server 302, 314 or access device 311-313 shown, for example, in FIG. 3, according to some embodiments of the present invention. The TTRMC server 314 comprises a processor 410, such as one or more processors, coupled to a communication device 420 configured to communicate via a communication network (not shown in FIG. 4). The communication device 420 may be used to communicate, for example, with one or more network access devices 311-313.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 can store a program 430 for controlling the processor 410. The processor 410 performs instructions of the program 430, and thereby operates in accordance with the present invention. For example, the processor 410 may receive information descriptive of an IPO including auction and pre-auction details and allocate shares according to rules defined by the details. The processor 410 may also transmit information comprising share allocation, pricing, or other information.

The storage device 430 can store Charitable Transaction risk management related data in a database 500, and other data 600 as needed. The illustration and accompanying description of the database presented herein is exemplary, and any number of other database arrangements can be employed besides those suggested by the figures.

### Data Structures

Referring now to FIG. 5, a design of a portion of database that can be utilized while implementing the present invention is illustrated. The database 500 can include a field 502 containing data descriptive of risk criteria 502, as well as a field 504 containing data indicative of a weighting. Another field 506 can hold data descriptive of a suggested action and still another field 508 can contain data related to a Traveler's name.

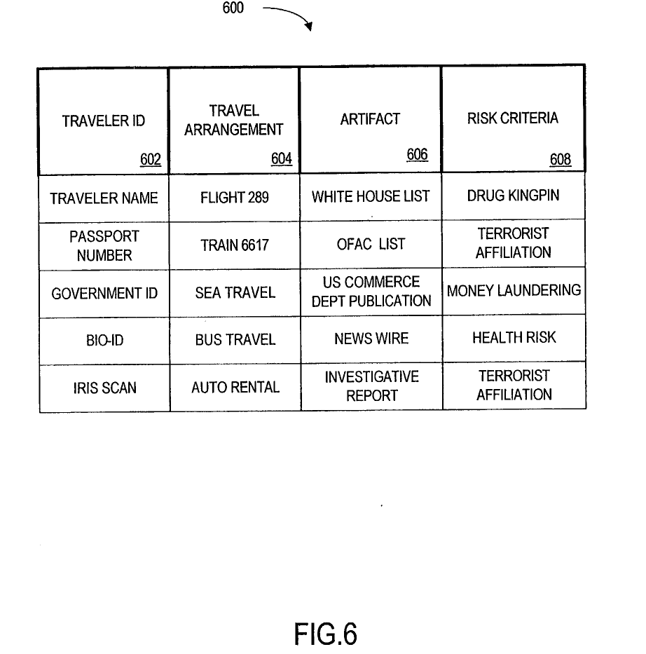

Referring now to FIG. 6, another portion of a data structure that can be utilized while implementing the present invention is illustrated. For example, the data structure can include data fields for storing datum descriptive of a Traveler's identification 602, a Travel Arrangement 604, an informational artifact 606, and risk criteria 608. Various embodiments can include data fields that are linked or associated with different techniques well known in the arts, such as hierarchical or relational linking. Obviously, other data fields storing data utilized in various facets of the present invention can also be included. The data can be arranged and accessed using any known data storage and accessing techniques.

### Graphical User Interface

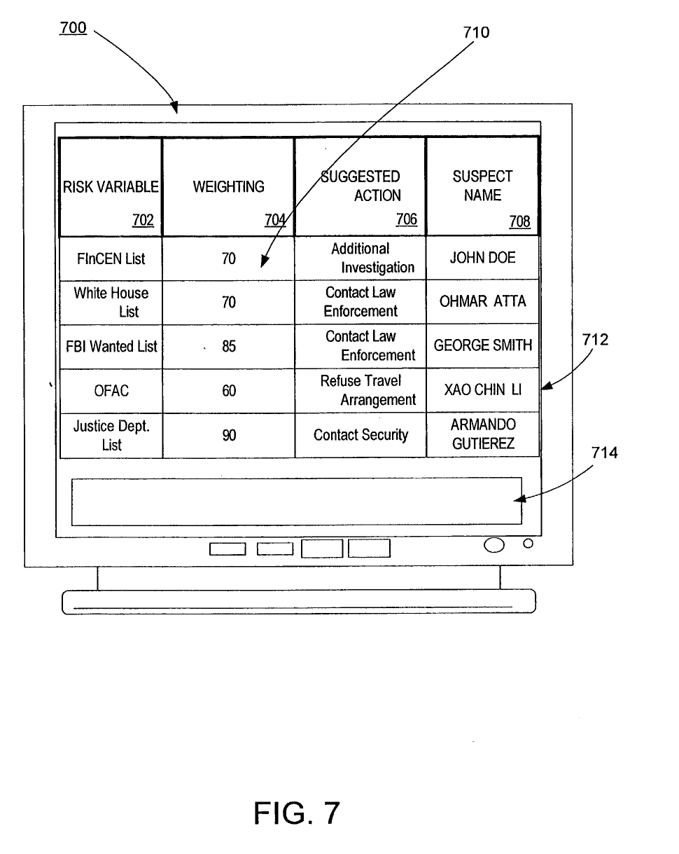

Referring now to FIG. 7, an exemplary GUI 700 that can be utilized while practicing the present invention is illustrated. The GUI can be presented on a network access device 311-313 or any other type of terminal or interactive station capable of creating a display pursuant to an electronic signal. The GUI can include areas prompting for information, such as in the form of a key word or a question 702-708. Areas can also be included for receiving an appropriate response 712, such as an area to receive text, allow a selection from choices proffered, or otherwise interactively receive data or other input into the TTRMC server 314. A programmable user interactive device, such as a checkbox, X field, yes/no filed, programmable icon, hyperlink, push button or other device can also be utilized to indicate an answer, or otherwise input information. A category weighting area 710 can also be indicated on the GUI 700 that allows the display or modification of weighting value, such as a numerical value, that can be utilized to calculate a risk quotient. Another area 714 can include an area for display of a report generated by the TRRMC 101.

A number of embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for managing risk related to a travel arrangement comprising the steps of:
receiving into a computer system data descriptive of informational artifacts with content generally related to at least one of: reputational, regulatory and physical risk;
defining within the computer system one or more travel arrangement risk criteria;
receiving into the computer system data descriptive of a travel arrangement comprising identification data for at least one traveler;
associating within the computer system at least some of the data descriptive of the travel arrangement with one or more risk criteria and with one or more informational artifacts related to at least one of: reputational, regulatory and physical risk; and
generating a report with contents comprising the data descriptive of a travel arrangement that is associated with one or more risk criteria and associated with one or more informational artifacts related to at least one of: reputational, regulatory and physical risk and also comprising a description of the one or more informational artifacts associated with the data descriptive of a travel arrangement and a description of the risk criteria.

2. The method of claim 1 wherein the data descriptive of the at least one travel arrangement comprises a payment vehicle for at least one travel reservation.

3. The method of claim 1 additionally comprising the step of:
generating in the computer system a risk quotient indicative of a quantitative amount of at least one of: reputational risk; physical risk, legal risk and regulatory risk; and the risk quotient is based upon at least one of: the risk criteria associated with the data descriptive of a travel arrangement; a weighted value of the data associated with such risk criteria; and the content of an informational artifact associated with the data descriptive of a travel arrangement.

4. The method of claim 1 additionally comprising the step of generating a suggested action based upon at least one of: the risk criteria associated with the data descriptive of a travel arrangement; a weighted value of the data associated with such risk criteria; and the content of an informational artifact associated with the data descriptive of a travel arrangement.

5. The method of claim 4 wherein the suggested action comprises requiring additional details descriptive of at least one of: the traveler; a financial account associated with a payment for the travel arrangement; a pattern of destinations comprising the travel arrangement; and articles involved in the travel arrangement.

6. The method of claim 4 wherein the suggested action comprises completing the travel arrangement.

7. The method of claim 4 wherein the suggested action comprises notifying at least one of: a security personnel, law enforcement agency; a government official and a travel provider.

8. The method of claim 1 additionally comprising providing the report to at least one of: security personnel and law enforcement personnel that will travel on the travel arrangement.

9. The method of claim 8 additionally comprising the steps of associating data relating to one or more seating assignments comprising a travel arrangement with the report contents.

10. A computer implemented method for monitoring risk related to travel comprising the steps of:
receiving into a computer system data descriptive of informational artifacts with content generally related to travel arrangements and at least one of: reputational, regulatory and physical risk;
identifying one or more travel arrangements;
receiving into the computer system data descriptive of any travel reservations made for each travel arrangement, wherein each travel reservation at least comprises identification data for one or more travelers;
defining within the computer system one or more travel related risk criteria;
associating within the computer system at least some of the data descriptive of at least one travel reservation with one or more of the risk criteria related to at least one of: reputational, regulatory and physical risk;
associating within the computer system at least some of the data descriptive of at least one travel reservation with data descriptive of one or more informational artifacts related to at least one of: reputational, regulatory and physical risk; and
generating a report with contents comprising the data descriptive of the travel arrangement that is associated with one or more of the risk criteria and associated with one or more of the informational artifacts and also comprising a description of the one or more informational artifacts associated with the data descriptive of a travel arrangement.

11. The computer implemented method of claim 10 additionally comprising the step of selecting a preferred travel arrangement based upon the contents of the report.

12. The method of claim 10 wherein the travel arrangement is identified based upon an origination point and a destination point of the travel arrangement.

13. The method of claim 10 wherein the travel arrangement is identified based upon details of the travel arrangement comprising one or more of: an origination point and a destination point of the travel arrangement; a scheduled time for the travel arrangement; a number of connections involved in the travel arrangement; and a preferred provider for the travel arrangement.

14. The method of claim 10 additionally comprising the steps of:
receiving into a computer system data descriptive of informational artifacts with content generally related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement;
associating one or more of the informational artifacts with content generally related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement;
generating the report with additional contents descriptive of the artifacts related to one or more of: security measures involved in a travel arrangement; time required to proceed through security measures involved in a travel arrangement; records of security breaches in facilities involved in the travel arrangement; policies relating to luggage; and ease of access to and from a facility involved in the travel arrangement; and
selecting a preferred travel arrangement based upon the contents of the report.

15. The method of claim 10 wherein the data descriptive of travel reservations comprises a payment vehicle and the method additionally comprises the step of performing a risk management clearinghouse check on a person associated with the payment vehicle.

16. The method of claim 10 additionally comprising the steps of:
generating in the computer system a risk quotient for one or more travel reservations, wherein the risk quotient is indicative of a quantitative amount of at least one of: reputational risk; physical risk, legal risk and regulatory risk; and the risk quotient is based upon at least one of: the travel related risk criteria; a weighted value of the data associated with the travel related risk criteria; and the content of an informational artifact associated with the data descriptive of a travel arrangement.

17. The method of claim 16 additionally comprising the steps of:
aggregating two or more risk quotients, wherein each risk quotient is indicative of an amount of one of: reputational risk; physical risk, legal risk and regulatory risk associated with a travel reservation, and the aggregation of the risk quotients is indicative of a total quantitative amount of such risk associated with the travel arrangement.

18. The method of claim 17 additionally comprising the step of including in the report an association of one or more of: the data descriptive of the travel arrangement; the risk criteria; and the informational artifacts with a seating assignment associated with the travel arrangement.

19. The method of claim 10 wherein the computer system associates at least some of the data descriptive of each travel reservation with one or more risk variables.

20. A computerized system for managing risk associated with a travel arrangement, the system comprising:
a computer server accessible with a computerized device via a communications network; and
executable software stored on the server and executable on demand, the software operative with the server to cause the system to:
receive into a computer system data descriptive of informational artifacts with content generally related to at least one of: reputational, regulatory and physical risk;
define within the computer system one or more travel arrangement risk criteria;
receive into the computer system data descriptive of a travel arrangement comprising identification data for at least one traveler;
associate within the computer system at least some of the data descriptive of the travel arrangement with one or more risk criteria and with one or more informational artifacts related to at least one of: reputational, regulatory and physical risk; and
generate a report with contents comprising the data descriptive of a travel arrangement that is associated with one or more risk criteria and associated with one or more informational artifacts related to at least one of: reputational, regulatory and physical risk and also comprising a description of the one or more informational artifacts associated with the data descriptive of a travel arrangement and a description of the risk criteria.

21. Computer executable program code residing on a computer-readable medium, the program code comprising instructions for causing a computer to:
receive into a computer system data descriptive of informational artifacts with content generally related to at least one of: reputational, regulatory and physical risk;
define within the computer system one or more travel arrangement risk criteria;
receive into the computer system data descriptive of a travel arrangement comprising identification data for at least one traveler;
associate within the computer system at least some of the data descriptive of the travel arrangement with one or more risk criteria and with one or more informational artifacts related to at least one of: reputational, regulatory and physical risk; and
generate a report with contents comprising the data descriptive of a travel arrangement that is associated with one or more risk criteria and associated with one or more informational artifacts related to at least one of: reputational, regulatory and physical risk and also comprising a description of the one or more informational artifacts associated with the data descriptive of a travel arrangement and a description of the risk criteria.
